(19) United States
(12) Patent Application Publication
(10) Pub. No.: US 2013/0191608 A1
(43) Pub. Date: Jul. 25, 2013

(54) METHOD FOR NON-VOLATILE MEMORY REALLOCATION FOR INFORMATION STORAGE

(71) Applicant: Michael Ray Christian, Carmel, IN (US)

(72) Inventor: Michael Ray Christian, Carmel, IN (US)

(73) Assignee: THOMSON LICENSING, Issy de Moulineaux (FR)

(21) Appl. No.: 13/877,840

(22) PCT Filed: Feb. 16, 2011
(86) PCT No.: PCT/US11/00282

§ 371 Date: Apr. 4, 2013

(30) Foreign Application Priority Data
Oct. 28, 2010 (US) 61407659

(51) Int. Cl. G06F 12/02

(52) U.S. Cl. CPC G06F 12/02
USPC 711/171; 711/170

(57) ABSTRACT

A set-top box includes a non-volatile memory for storing application code images. To enable the memory to store an application code image larger than a designated storage area associated therewith, the application code image undergoes separation into primary and secondary parts. The memory undergoes reallocation to create a separate storage area for storing the secondary part of the received information, whereas, while the primary part of the received information gets stored in the designated storage area.

### CROSS-REFERENCE TO RELATED APPLICATIONS

This application claims priority under 35 U.S.C. 119(e) to U.S. Provisional Patent Application Ser. No. 61/407,659, filed Oct. 28, 2010, the teachings of which are incorporated herein.

### TECHNICAL FIELD

This invention relates to a technique for reallocating non-volatile memory within an electronic device, and more particularly, a receiver, such as, but not limited to, a set-top box.

### BACKGROUND ART

Various content-receiving electronic devices (“receivers), such as, but not limited to, television sets and set-top boxes, often contain a flash chip or non-volatile storage mechanism that stores a combination of code and data used by the receiver for its normal operation. The code portion typically includes a boot loader and one or more application code images which provide control instructions and the like. The data portion contains parameters and other configuration information used by the receiver.

Multiple application code images can exist in the receiver for redundancy. If one application code image becomes corrupt, the receiver will run an alternate application code image. The term “active image” refers to the currently running application code image. From time to time, a content service provider can replace the non-active application code images by various, well-known mechanisms (Open Cable Common Download, USB memory stick, etc.). The application code images have a maximum size based on the non-volatile memory allocation determined during receiver design.

In some but not all receivers, the boot loader contains fixed pointers to the application code images. The boot loader chooses the application code image to load based on one or more boot loader configuration parameters. In some but not all receivers, the boot loader has minimal functionality. In this regard, the boot loader simply serves to load the current active application in a memory. The functionality for replacing a non-active code image resides in the current active code image.

In response to customer demand, receiver manufacturers often add features to the receiver that would require the application code images to exceed the available allocation space in memory. Replacing the boot loader to point to different application code image locations in the non-volatile storage mechanism often does not prove practical or even desirable. Further, erasing all the code images during application code image replacement should never occur. If a power failure occurs during erasure of all of the code images (or the boot loader), the receiver could become non-functional.

### BRIEF SUMMARY OF THE INVENTION

Briefly, in accordance with a preferred embodiment of the present principles, a method for storing received information in a memory commences by separating the incoming information into the first and second portions. Reallocation of the memory then occurs to establish a second information portion storage location for storing the second portion of the incoming information, whereas the first portion of the incoming information undergoes storage in the designated storage location in memory.

### BRIEF DESCRIPTION OF THE DRAWINGS

FIG. 1 depicts a block schematic diagram of a content receiving device for practicing the information storage technique of the present principles.

FIG. 2 depicts a block diagram of a non-volatile storage element within the content receiving device prior to re-allocation; and

FIG. 3 depicts a block diagram of the non-volatile storage element of FIG. 2 following reallocation in accordance with the present principles.

### DETAILED DESCRIPTION

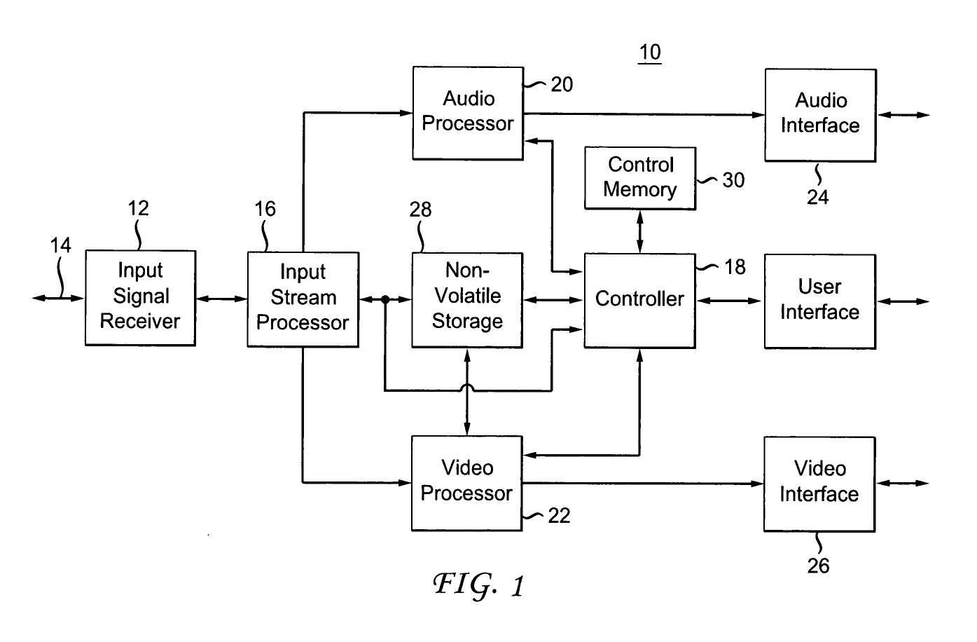

FIG. 1 depicts a block schematic diagram of a set-top box 10 which constitutes but one example of a content receiving device capable of practicing the memory allocation technique of the present principles. The set-top 10 includes an input signal receiver 12 for tuning a particular channel of a multi-channel content stream 14 provided by a content provider, such as cable television, satellite television, or telecommunication service provider (not shown). An input signal processor 16, under the control of a controller 18, processes the channel stream tuned by the input signal receiver 12. The processing performed by the input signal processor 16 will depend on the nature of the tuned channel stream. For example, the input signal processor 16 would need to perform decoding if the input stream tuned by the input signal stream receiver 12 were encoded.

Following signal processing, the input stream processor 16 splits the processed channel stream signal into an audio portion for receipt by an audio processor 20, and a video portion for receipt by a video processor 22, respectively. Like the input stream processor 16, both the audio processor 20 and the video processor 22 operate under the control of the controller 18. An audio interface 24 receives and reproduces the audio portion of the processed channel stream produced by the audio processor 20. A video audio interface 26 receives and reproduces the video portion of the processed channel stream produced by the video processor 22.

A non-volatile memory device 28, such as a flash memory, has links to the audio and video processors 20 and 22, respectively, as well as the controller 18 for supplying information thereto, and for storing information therefrom. In addition, the controller 18 also enjoys a link to a control memory 30 which can store program instructions for the controller. A user can enter commands to, and receive status information from the controller 18 via a user interface 32.

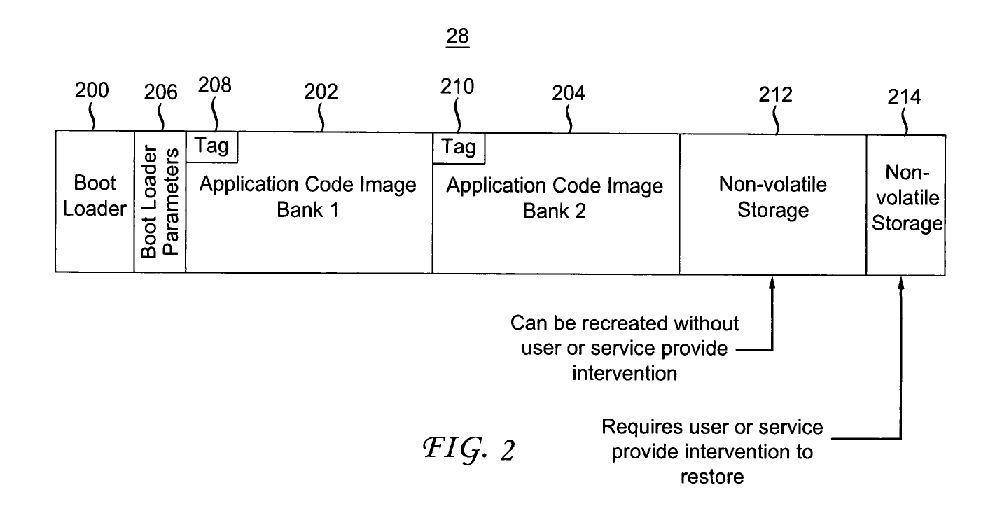

FIG. 2 depicts a typical allocation of the non-volatile memory 28 of FIG. 1. A first storage location 200 in the memory 28 stores a boot loader which functions to point to particular data structures stored elsewhere in the memory 28. For example, the boot loader can point to one of a first and a second application code images stored in storage locations 202 and 204, respectively, sometimes referred to as “Bank 1” and “Bank 2” respectively. The operation of the boot loader stored in storage location 200 depends on the boat loader parameters stored in storage location 206 of the non-volatile memory 28.

The first and second application code images stored in storage locations 202 and 204, respectively, each have associated tags stored in sub-locations 208 and 210. Each tag associated with a corresponding application code image uniquely identifies the code image for use by a specific model set-top box made by a particular manufacturer. These tags prevent the loading of an application code image meant for another set-top box.

In addition to the storage locations 200-210, the non-volatile memory 28 of FIG. 1 can contain additional storage locations, as exemplified by the storage locations 212 and 214. In practice, the controller 18 can change the storage locations 200-210 as well as storage location 212, without intervention by the user or the service provider. For some set-top boxes or for at least some of the data stored therein, the storage location 214 requires user or service provider intervention to change.

The allocation of the memory 28 depicted in FIG. 2 does not offer any indication of which application code image is currently active. In some instances a multi-stage process will become necessary to obtain the final desired allocation of the memory 28. If service provider makes use of the Open Cable Common Download as the code upgrade path, the service provider will need to allocate bandwidth within the service delivery network for all of the stages of set-top box upgrades, as long as the set-top box model remain supported. Often, a service provider will store a quantity of set-top boxes in a warehouse for an extended period of time. Further, in some instances, a set-top box could remain powered off for an extended period in a subscriber's home. When a “dormant” set-top box later becomes attached to the service provider's network, such a set-top box will require all stages of upgrades. The need to offer all stages of upgrades will preclude implementation of some of the solutions proposed hereinafter to identify the currently active application code image.

A first possible solution to allocate memory when the current application code image becomes to large would be to always store the current application code image in the same location in the non-volatile memory 28 of FIG. 2, for example storage area 204 (“Bank 2”). Thus, storage area 204 always holds the currently active application code image. Upon a future application code image upgrade, the contents of storage area 204 (Bank 2) will get replaced. To allow the currently active application code image to extend into vacant storage space, the storage space within the non-volatile memory 28 of FIGS. 1 and 2 typically gets compacted toward high memory.

The storage area 202 of FIG. 1 (designated as “Bank 1”) serves to hold a backup application code image that requires limited intelligence. In other words, the backup application code image need only possess enough intelligence to load an application code image into storage area 204 (Bank 2) should the application code image stored therein become corrupted.

This approach affords the advantage of obviating the need to replace the boot loader. Using this approach, the boat loader will always point to storage area 204 (Bank 2.) However, this approach suffers from the disadvantage that if no knowledge exists before memory reallocation of whether storage area 202 (Bank 1) or storage area 204 (Bank 2) contains the active application code image, then a multi-stage upgrade process becomes necessary.

Another possible solution to allocate memory when the current application code image becomes too large would be to upgrade the boot loader to change the application code image start addresses. This approach allows two application code images of equal size. However, this approach incurs the disadvantage that in the absence of any advance knowledge as to which storage areas 202 and 204 (Banks 1 and 2, respectively) holds the currently active application code image, then a multi-stage upgrade process becomes necessary. Further, the set-top box 10 will become non-functional if a power failure occurs during the upgrade. Lastly downgrading to an older version of the application code image becomes impossible if the older application code image does not understand the new allocation of the non-volatile memory 28 of FIGS. 1 and 2.

There exists a third possible solution for to allocate memory when the current application code image becomes too large. This solution entails placing a new secondary boot loader at the bottom of storage area 202 of FIG. 2 (Bank 1) to allow for flexible application code image start addresses. Banks 1 and 2 get shifted within in the non-volatile memory 28 of FIGS. 1 and 2 and get increased in size to reallocate part of the non-volatile data storage location. This approach obviates the need to replace the existing boot loader and also allows two application code images of equal size.

However, this approach incurs the disadvantage that in the absence of any advance knowledge as to which storage areas 202 and 204 (Banks 1 and 2, respectively) holds the currently active application code image, then a multi-stage upgrade process becomes necessary. Further, the receiver will become non-functional if a power failure occurs during the upgrade. Lastly downgrading to an older version of the application code image becomes impossible if the older application code image does not understand the new allocation of the non-volatile memory 28 of FIGS. 1 and 2.

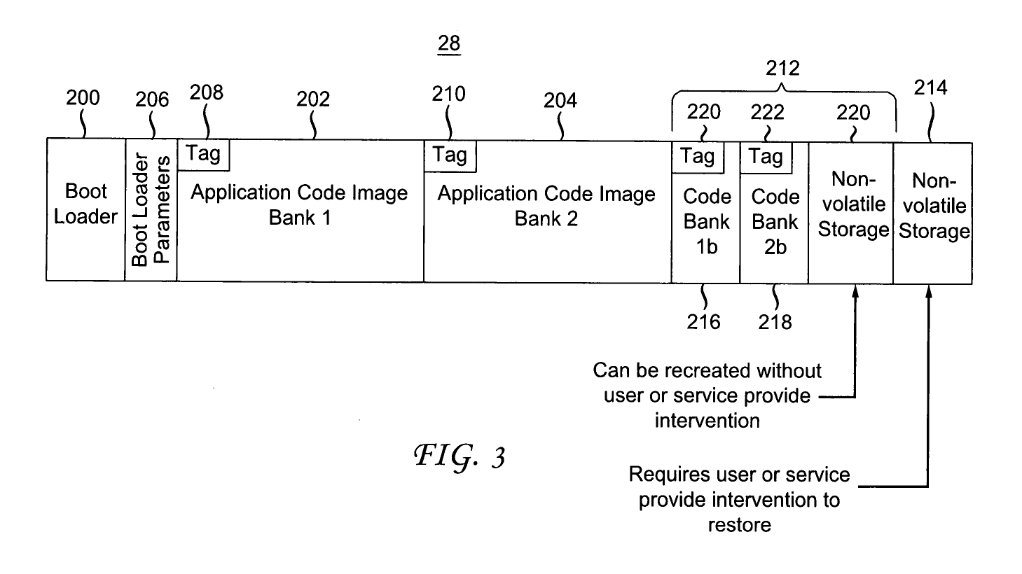

FIG. 3 depicts allocation of the non-volatile memory 28, in accordance with the present principles, which overcomes the disadvantages of the aforementioned possible allocation techniques. As discussed in greater detail hereinafter, the allocation of the memory 28 depicted in FIG. 3 affords compacted data storage, taking into consideration the following constraints:

(1) the original structure of the storage area contains configuration details that cannot undergo movement in the non-volatile memory 214 without either the home user or the service provider having to reconfigure the receiver for normal operation.

(2) the configuration details reside together at one end (either high or low) of the existing data storage area; and

(3) the original structure of the storage area contains data in the non-volatile memory 212 that does not require intervention by either the subscriber or service provider before being recreated or reacquired.

The allocation of memory 8 in accordance, which is depicted in FIG. 3, contains many similarities with the allocation technique of FIG. 2. To that end like reference numbers appear in FIG. 3 to refer to the same areas within the memory 28 of FIG. 2. In other words, the areas 200-210 in memory 28 of FIG. 3 store the same items (e.g., the boot loader, boot loader parameters, application code images and tags) as the areas 200-210 in FIG. 2.

The allocation of memory 28 depicted in FIG. 3 differs from the allocation of memory 28 of FIG. 2 in the following manner. The storage area 212 of FIG. 2 gets reallocated in FIG.

3 into sub-areas 216, 218 and 220. The sub-areas 216 and 218 bear the legends “Code Bank 1b” and “Code Bank 2b” and each stores a portion of first and second application code images, respectively, as hereinafter described. Thus, in contrast to the allocation of memory 28 depicted in FIG. 2 in which the storage location 212 may be vacant or used for data that can be reacquired without subscriber or service provider intervention , the memory allocation of FIG. 3 makes use of the storage location 212 to store parts of application code images. The allocation of memory 28 depicted in FIG. 3 maintains the storage area 214 as before.

In accordance with the present principles, upon the receipt of an application code image for storage in the memory 28 of FIG. 3, an examination of the size of the application code image occurs to determine the capability of areas 202 and 204 to store that application code image. If the size of the received application code image permits storage in one of the storage areas 202 and 204 of FIG. 3, then storage occurs with no need for any further processing.

However, if the received application code image exceeds the size of one of the storage areas 202 and 204 of FIG. 3, then the received application code image undergoes division into first and second portions, hereinafter referred to as primary and secondary parts, respectively. The division of the received application code image occurs in such a manner so that the primary part of the application code image can fit into the original application code image space (i.e., one of areas 202 and 204 of FIG. 3). The secondary part of the application code image gets stored into one of the two vacated data sections (areas 216 and 218 of FIG. 3) reallocated for this purpose. Loading of the primary part of the application code image into one of the areas 202 and 204 of FIG. 3 typically occurs through the legacy techniques. The primary part of the application code image has the capability of operating normally but with reduced functionality until execution of the secondary part loaded into one of the reallocated storage areas. The primary part of the application code image will contain a new feature to load the secondary part of the application code image in the reallocated storage area (e.g., one of storage areas 216 and 218).

As discussed previously, the application code images stored in the non-volatile memory 28 of FIGS. 2 and 3 have associated tags that identify the manufacturer and model of set-top box for which the application code image will operate. In accordance with the present principles, the secondary part of each application code image has a tag for this purpose. To that end, the re-allocated areas 216 and 218 include sub-areas 220 and 222, respectively, for storing the tags associated with the secondary application code image parts stored in the reallocated areas. A set-top box running an older application code image will only load the primary part of a newly received application code image. The newly loaded application code image will understand the new tags and load the secondary part in to the reallocated storage.

In connection with the above-described allocation of memory 28 of FIG. 3, the service provider must make both the primary and secondary parts of the code image available to the set-top box 10. If the service provider decides to downgrade to an older code image that does not recognize the new reallocation of memory 28, the service provider will load an old code image into the non-activate application bank (e.g., one of storage areas 202 and 204 of FIG. 3) and then make the old application code image active. Upon loading, the old code image will detect that reallocation of the memory 28 has occurred and the memory as reallocated does not contain the data that the old application code image expects. Under such circumstances, the old application code image will initiate reloading of that data without user or service provider intervention.

The allocation of memory 28 of FIG. 3 in accordance with the present principles affords the advantage of obviating the need to replace the boot loader in the non-volatile memory. Further, the allocation of memory 28 of FIG. 3 does not require reallocating or erasing of the existing application code images. In accordance with the present principles, one of the newly vacated storage areas 216 and 218 get allocated to the secondary part of a newly received application code images. The primary part of each received application code images get allocated to one of the storage areas 202 and 204, respectively. In the present example, the application code image, whose primary part resides in storage area 202 (Bank 1), makes use of the reallocated storage area 216 (Bank1b) for its secondary part. Likewise, the application code image, whose primary part resides in storage area 204 (Bank 2), makes use of the reallocated storage area 218 (Bank 2b) for its secondary part. If the two parts of a received application code image are inseparably linked together, the service provider must now change both the primary and secondary parts at the same time. If the primary and secondary parts of a received application code image are not inseparably linked, then the primary and secondary parts can undergo upgrading independently.

In some instances problems can arise after loading a newly received application code image with new features. When such problems arise, a need then exists to revert to an older version of the application code image. The reallocation of memory 28 of FIG. 3 in accordance with the present principles does not prevent older versions of the application code from operating normally if reloaded into the set-top box 10. Moreover, the memory allocation of the present principles allows for code upgrades to new application code images that make use the memory allocation. Further, the memory allocation of the present principles does not prevent code “downgrades” where an older application code image that does not understand the new allocation structure may still get loaded and function normally.

As discussed previously, the application code images whose primary parts get allocated to the storage areas 202 and 204, respectively, make use of the reallocated storage areas 216 and 218, respectively, for their associated secondary parts. However, a primary application code image part could make use of either of the application code image secondary parts. Thus, the application code image whose primary part resides in Bank 1 (storage area 202 of FIG. 3) can make use of the secondary application code image parts stored in either Bank 1b (storage area 216) or Bank 2b (storage area 218).

The foregoing describes a technique for allocating a memory in a receiving device, such as, but not limited to, a set-top box.

1. A method for storing received information in a memory, comprising the steps of:
separating the received information into the primary and secondary parts;
reallocating the memory to establish a secondary information part storage location for
storing the secondary part of the incoming information, and
storing the first part the incoming information in a designated storage location in memory.

2. The method according to claim 1 further including the step of uniquely associating the secondary part of the received information with the primary part of the received information so the secondary part gets retrieved upon retrieval of the primary part.

3. The method according to claim 1 further including the steps of:
receiving first and second received information, each having primary and secondary parts; and
associating the secondary parts of first and second received information with the primary part of the second and first information, respectively.

4. The method according to claim 1 further comprising the step of tagging the primary and secondary parts of the received information to identify suitability of the primary and secondary parts of the received information for an electronic device.

5. The method according to claim 1 wherein the reallocation step further comprises the step of reallocating a storage area, assignable without intervention, to now receive the secondary part of the received information.

6. The method according to claim 1 wherein the primary part of the received contains data directing downloading of the secondary part of the received information.

7. A method for storing received information in a memory, comprising the steps of:
determining whether the received information has a size exceeding that of a designated storage location in the memory, and if so,
separating the received information into the primary and secondary parts;
reallocating the memory to establish a secondary information part storage location for
storing the secondary part of the incoming information, and
storing the first part the incoming information in the designated storage location in memory.

8. The method according to claim 7 further including the step of uniquely associating the secondary part of the received information with the primary part of the received information so the secondary part gets retrieved upon retrieval of the primary part.

9. The method according to claim 7 further including the steps of:
receiving first and second received information, each having primary and secondary parts; and
associating the secondary parts of first and second received information with the primary part of the second and first information, respectively.

10. The method according to claim 7 further comprising the step of tagging the primary and secondary parts of the received information to identify suitability of the primary and secondary parts of the received information for an electronic device.

11. The method according to claim 7 wherein the reallocation step further comprises the step of reallocating a storage area, assignable without intervention, to now receive the secondary part of the received information.

12. The method according to claim 7 wherein the primary part of the received information contains data directing downloading of the secondary part of the received information.
